(19) United States
(12) Patent Application Publication
(10) Pub. No.: US 2020/0112091 A1
(43) Pub. Date: Apr. 9, 2020

(54) Device and Method for Adaptable Electromagnetic Doppler Surface

(71) Applicant: The United States of America as represented by the Secretary of the Navy, San Diego, CA (US)

(72) Inventors: Sara Wheeland, San Diego, CA (US); John D. Rockway, San Diego, CA (US); Israel Perez, San Diego, CA (US); Oren Sternberg, San Diego, CA (US)

(73) Assignee: The United States of America as represented by the Secretary of the Navy, San Diego, CA (US)

(21) Appl. No.: 16/150,431

(22) Filed: Oct. 3, 2018

(51) Int. Cl. H01Q 3/10; H01Q 3/04; G06F 17/50; B63B 9/00

(52) U.S. Cl. CPC H01Q 3/10; B63B 9/003; G06F 17/5009; H01Q 3/04

(57) ABSTRACT

A method to create an electromagnetic Doppler surface comprising the steps of using an array of conductive elements, wherein the conductive elements mechanically move in individual orbits, and wherein the conductive elements are configured to combine and form a Doppler surface; using mechanical, phase-induced motion as a mechanism by which to move the conductive elements in individual orbits; creating a surface with a controllable Doppler return using two-dimensional motion.

### CROSS-REFERENCE TO RELATED APPLICATIONS

This application is a nonprovisional application claiming priority to U.S. Patent Application Ser. No. 62/693,058, filed on Jul. 2, 2018, entitled “System and Method For Adaptable Electromagnetic Doppler Surface,” the entire content of which is fully incorporated by reference herein.

### FEDERALLY-SPONSORED RESEARCH AND DEVELOPMENT

The System and Method for Adaptable Electromagnetic Doppler Surface is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 104009.

### BACKGROUND

Mechanical-based modulation of electromagnetic (EM) fields has been studied for some time. EM modulation occurs naturally in the form of a Bragg-line high frequency scattering response from ocean surfaces. Attempts to engineer a similar response have resulted in studies involving the motion of helicopter blades and wind turbine blades to control EM radiation properties. Other attempts have focused on the detection of Doppler velocity shifts in the ultrasound and acoustic regimes, rather than on engineering a surface with a controllable response.

Additionally, the intersection between ocean dynamics and seagoing ships has an incredibly rich history ranging from early seagoing studies of the 1890s to computer animation to wave pools. Described herein is a complementary approach through the implementation of a dynamic, mechanized surface, with one embodiment representing a time-resolved, fully-developed sea. Gerstner theory, or trochoid wave theory, describes wave motion with water particles moving along circular orbits. The dynamics of the circular orbits are mapped to linearly actuated motion using a correction factor for the ocean height and velocity at a given point in time and space. The ocean is implemented as a two-dimensional trochoid surface and controlled using a dense array of microprocessors, sensors and actuator systems. Actuation is achieved through slide potentiometers. Time-resolved wave motion on this mechanized surface is demonstrated for sinusoidal and trochoid waves. The positions of wave heights and velocity are measured using time-of-arrival sensors. The feasibility of using a mechanized ocean surface is evaluated for heave experiments in ship design.

### BRIEF DESCRIPTION OF THE DRAWINGS

FIG. 1A shows a model of three-dimensional (3-D) trochoid waves.

FIG. 1B shows a model of two-dimensional (2-D) trochoid waves.

FIG. 2 shows an example of a Doppler surface with 2-D circular orbits with a certain phase offset.

FIG. 3 shows an example of a Doppler surface with 2D circular orbits with an alternate phase offset from FIG. 2.

FIG. 4 shows an example of a Doppler surface with 2D planar elliptical orbits.

FIG. 5 shows an example of a Doppler surface with solely vertical motion.

FIG. 6 shows an example of a Doppler surface with gears and steel ball bearings.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment”, “in some embodiments”, and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

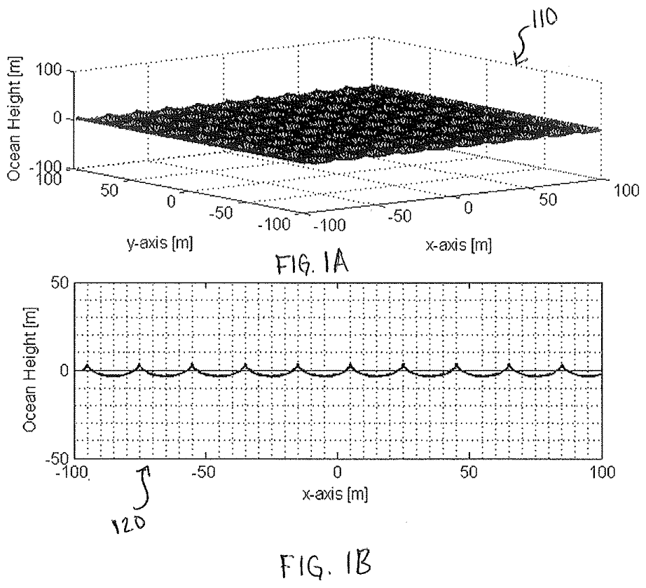

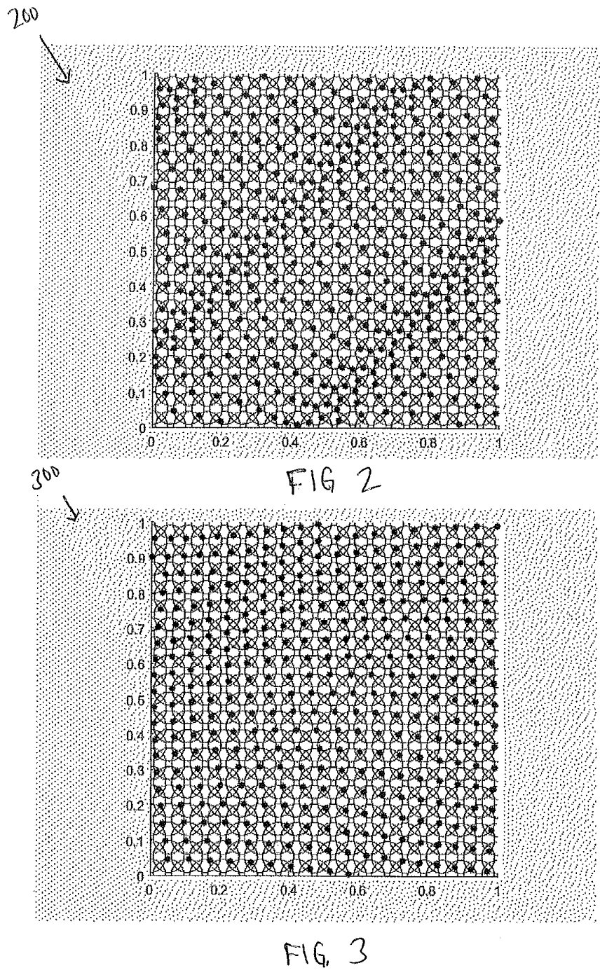

FIG. 1A shows a model of 3-D trochoid waves. FIG. 1B shows a model of 2-D trochoid waves. To better explore the Gerstner wave solution, FIGS. 1A and 1B allow for visualization of a propagating wave as described by the following equations:

$$\begin{matrix}X = {x}_{o} - \frac{\vec{k}}{k} cos ( \vec{k} \cdot {x}_{o} - ω t ) & ( 1 ) \\ Z = {x}_{0} - \frac{\vec{k}}{k} sin ( \vec{k} \cdot {x}_{o} - ω t ) & ( 2 )\end{matrix}$$

FIG. 1A is a model showing three-dimensional (3-D) trochoid waves. FIG. 1A has a graph 110 showing a set of linearly-spaced points defined in the (X, Y) plane, and representing the position of a fluid particle at rest. The particles are translated in time through equations (1) and (2) stated above. FIG. 1B shows a model of two-dimensional (2-D) trochoid waves. FIG. 1B has a graph 120 showing the combination of orbiting particles tracing out the shape of a trochoid wave propagating along the x-axis.

Graphs 110 and 120 first develop a physical environment. The numerical representation of a physical environment considers the size of the fluid region and the number of representative sample points. The fluid region is taken to be either a single line of fluid particles (2-D case seen in graph 120) or a grid (3-D case seen in graph 110). In either case, the region is planar with no depth at rest. Thus, the models in FIG. 1A and FIG. 1B are most concerned with the wave height profile rather than motion of fluid particles below the surface layer.

The number of sample points is chosen so as to sufficiently describe a wave propagating through the fluid region. The models in FIGS. 1A and 1B define the propagating wave by their amplitude, wave vector, frequency, and wave celerity (propagating velocity). These are related through equations 3 and 4 below. Once the physical environment is set up and the wave defined, a time vector is created to resolve the fluid particle positions in time.

$$\begin{matrix}c = \sqrt{\frac{g}{k}} & ( 3 ) \\ c = λ f & ( 4 )\end{matrix}$$

The models in FIGS. 1A and 1B are completely scalable and can represent large ocean swells or other wind-generated wave in smaller bodies of water. Although they are constrained to representing waves in fluid depths that are sufficiently high to allow for Gerstner theory to be valid.

FIG. 1B maps a wave height profile to fixed locations along the x-axis. This allows for creating a trochoid wave profile without orbital motion; an important distinction when implementing a mechanical version of model 120. An interpolative method was employed to constrain the motion to a single axis while accurately depicting the wave height profile. The x-position of each orbital is taken to be the resting position of the fluid particles. From here, the heights of the nearest particles on either side of the fixed x-position are chosen to be the interpolating points. With this method, the error is reduced as the sample resolution increases.

FIG. 2 shows one embodiment of a Doppler surface 200 with 2-D circular orbits with a certain phase offset. Doppler surface 200 has an array of conductive elements that can mechanically move in individual orbits. Each element has a phase offset from the surrounding elements. Doppler surface 200 has a controllable Doppler, or Bragg-line, return using 2-D or 3-D motion. The elements could be a steel ball rotating in a circular orbit, however alternate embodiments using other materials and orbit types are also possible.

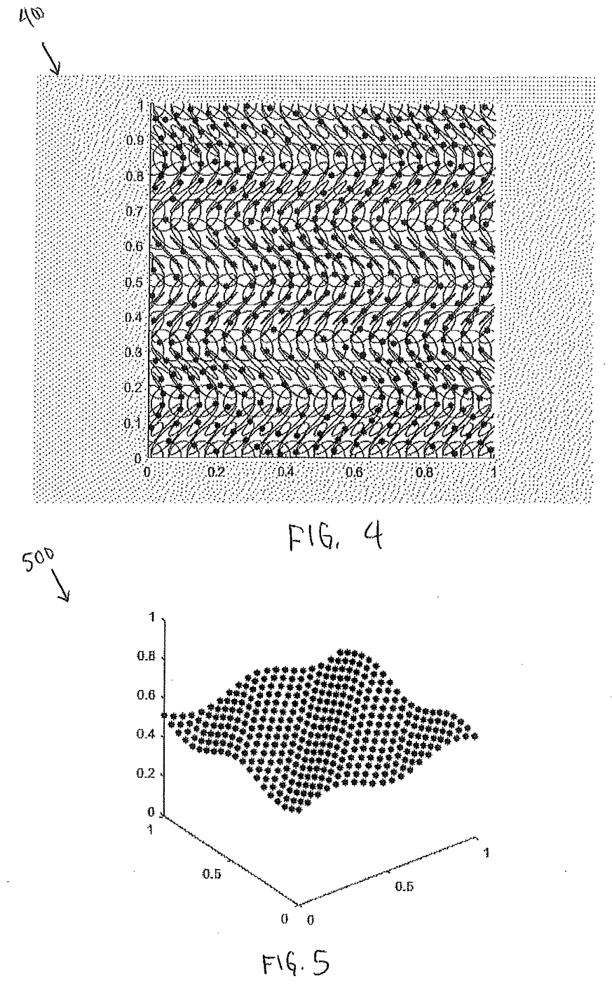

FIG. 3 shows an alternate embodiment of a Doppler/Trochoid surface 300 with 2-D circular orbits with a different phase offset from FIG. 2.

FIG. 4 shows an alternate embodiment of a Doppler surface 400 with 2-D planar elliptical orbits.

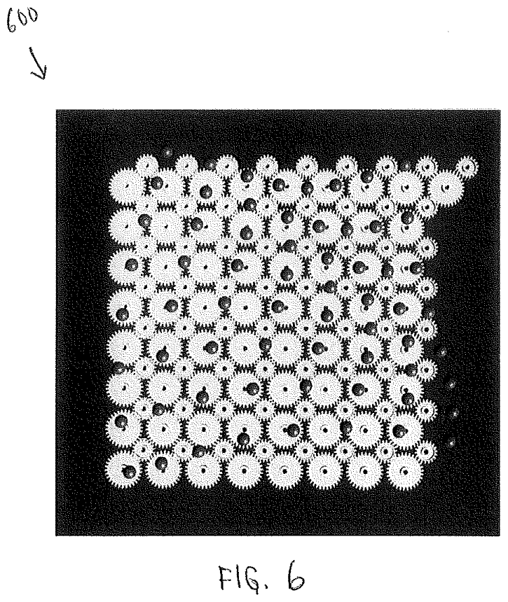

FIG. 5 shows an alternate embodiment of a Doppler surface 500 with solely vertical motion.

FIG. 6 shows an alternate embodiment of a Doppler surface 600 having a plurality of gears and steel ball bearings.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method to create an electromagnetic Doppler surface comprising the steps of:
using an array of conductive elements, wherein the conductive elements mechanically move in individual orbits, and wherein the conductive elements are configured to combine and form a Doppler surface;
using mechanical, phase-induced motion as a mechanism by which to move the conductive elements in individual orbits;
creating a surface with a controllable Doppler return using two-dimensional motion.

2. The method of claim 1, wherein the surface is created using three-dimensional motion.

3. The method of claim 1, further comprising the step of providing each element a phase offset from the surrounding elements.

4. The method of claim 3, further comprising the step of providing a network of gears and rotating ball bearings to form the conductive elements.

5. The method of claim 1, further comprising the step of using the Doppler surface to represent a time-resolved, fully-developed sea.

6. The method of claim 5, further comprising the step of evaluating the feasibility of the electromagnetic Doppler surface for heave experiments in ship design.

7. A method comprising:
applying modeling and simulation techniques to build, design, and implement a two-dimensional mechanical Doppler surface, wherein the Doppler surface comprises an array of conductive elements that mechanically move in individual orbits;
controlling the Doppler surface using a dense array of microprocessors, sensors, and actuator systems;
comparing a time-resolved wave motion for sinusoidal and trochoid profiles;
measuring wave heights and velocity using time-of-arrival sensors;
evaluating the feasibility of the mechanical Doppler surface for heave experiments in ship design.

8. The method of claim 7, further comprising the step of using mechanical, phase-induced motion as a mechanism by which to move the conductive elements in individual orbits.

9. The method of claim 8, further comprising the step of adjusting the phase-induced motion of the individual elements to fine-tune performance.

10. The method of claim 9, further comprising the step of using the two-dimensional mechanical Doppler surface to represent a time-resolved, fully-developed sea.

11. The method of claim 10, further comprising the step of using Gerstner's mathematical description of a wave traveling in an incompressible fluid to form the shape of the Doppler surface.

12. A device comprising:
an adaptable electromagnetic Doppler surface, wherein the Doppler surface comprises an array of conductive elements that mechanically move in individual orbits, and wherein each conductive element has a phase offset from the surrounding elements.

13. The device of claim 11, wherein the Doppler surface has a controllable Doppler return using two-dimensional motion.

14. The device of claim 11, wherein the Doppler surface has a controllable Doppler return using three-dimensional motion.

15. The device of claim 11, wherein the conductive elements comprise a steel ball rotating in a circular orbit.

16. The device of claim 11, wherein the Doppler surface comprises a network of gears and rotating ball bearings.

17. The device of claim 11, wherein the Doppler surface comprises physically individual elements moving in a required phase offset.
